(19) United States
(12) Patent Application Publication
(10) Pub. No.: US 2022/0245445 A1
(43) Pub. Date: Aug. 4, 2022

(54) SYSTEM AND METHOD FOR DATA ANALYTICS LEVERAGING HIGHLY-CORRELATED FEATURES

(71) Applicant: Chevron U.S.A. Inc., San Ramon, CA (US)

(72) Inventor: Julian A. Thorne, Houston, TX (US)

(21) Appl. No.: 17/164,099

(22) Filed: Feb. 1, 2021

(51) Int. Cl. G06N 3/08; G06N 3/04; G06F 16/28

(52) U.S. Cl. CPC G06N 3/08; G06F 16/285; G06N 3/04

(57) ABSTRACT

A method is described for data analytics using highly-correlated features which includes receiving a training dataset representative of a subsurface volume of interest; identifying at least two highly-correlated features in the training dataset; calculating a trend of the at least two highly-correlated features; calculating a residual of at least one of the highly-correlated features and the trend; and using data analytic methods on features in the training dataset that include one or more of these trend and residual combinations to predict a response variable. The method may be executed by a computer system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for data analytics and, in particular, to a method of data analytics that makes use of highly-correlated features.

### BACKGROUND

Data analytics, alternatively called data mining or data science, uses optimization methods to fit non-linear functions of explanatory variables (features) to a response variable. Feature selection is the process of identifying a subset of relevant features for use in the model construction. Since the optimization methods are so non-linear, in order to avoid spurious correlation in standard state-of-the-art methods, a set of feature vectors that are highly correlated are replaced by only one member of that set, such as the method disclosed in US 2019/0188584 A1. However, this will remove potentially valuable information that is present in the original feature vectors.

There is an opportunity to leverage highly correlated features for improved data analytics.

### SUMMARY

In accordance with some embodiments, a method of data analytics including receiving a training dataset representative of a subsurface volume of interest; identifying, via the one or more computer processors, at least two highly-correlated features in the training dataset; calculating, via the one or more computer processors, a trend of the at least two highly-correlated features; calculating a residual of at least one of the highly-correlated features and the trend; and using data analytic methods on features in the training dataset that include one or more of these trend and residual combinations to predict a response variableis disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates elements of a method of data analytics, in accordance with some embodiments; and

FIG. 2 is a block diagram illustrating a data analytics system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of data analytics. The data analytics methods and systems provided herein may be used for prediction of hydrocarbon production.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Hydrocarbon exploration and production results in a huge amount of data. This may include geological data, geophysical data, and petrophysical data. It may also include production data. Data analytics can extract meaning from this data in order to make predictions for identifying and producing hydrocarbons. For example, well-log petrophysical data and seismic attributes can be used to predict the observed variations in gas or oil production across a field or basin. Data analytic tools such as an ensemble of regression or classification decision trees can be trained on collocated well-logs, seismic, and production data to generate a prediction function. The prediction function is then applied on interpolated petrophysical property maps or volumes and the seismic attributes to predict the desired response variables such as estimated ultimate recovery. Since well completion parameters can also influence production data analytics is also used to normalize out these effects.

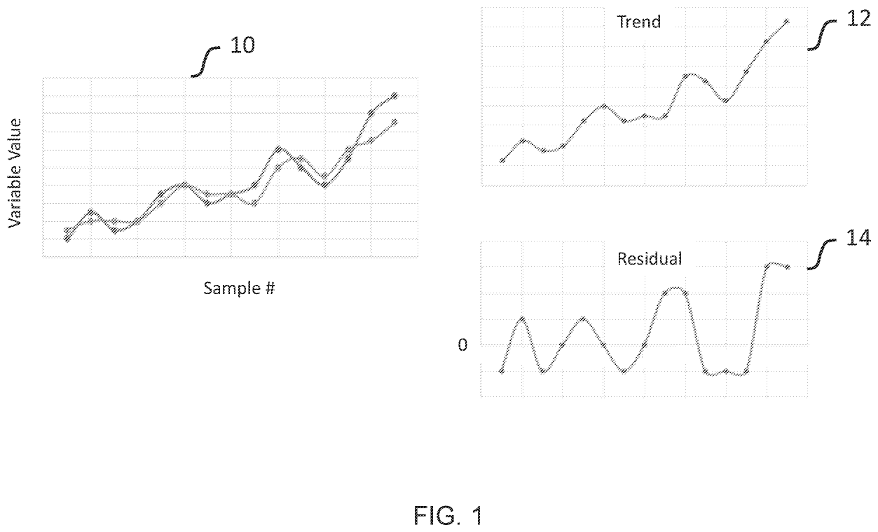

In the present invention, a set of two highly-correlated features is not replaced by one of them; instead, it is replaced by the trend of the two features and the residual of one of the features from the trend. For example, the petrophysical properties of pyrite % and kerogen % may be related with a correlation coefficient of 0.90. This example is not meant to be limiting; any two features with a correlation coefficient of at least 0.60 may be considered for this invention. The trend may be simply calculated using linear regression. The trend preserves the information that is contained in either of the features taken one at a time. The residual adds important information that reflects the difference between the two features. This is demonstrated in FIG. 1 where the two features shown in panel 10 are easily seen to be highly correlated. The trend of the two features is shown in panel 12 and the residual is shown in panel 14.

Data analytic methods can then be used on the training data features that include trend and residual combinations to predict response variables such as hydrocarbon production volumes. Data analytic methods in general optimize the weighting of each feature in a highly non-linear response function that can be used to predict the response variable in the subsurface volume away from the well control.

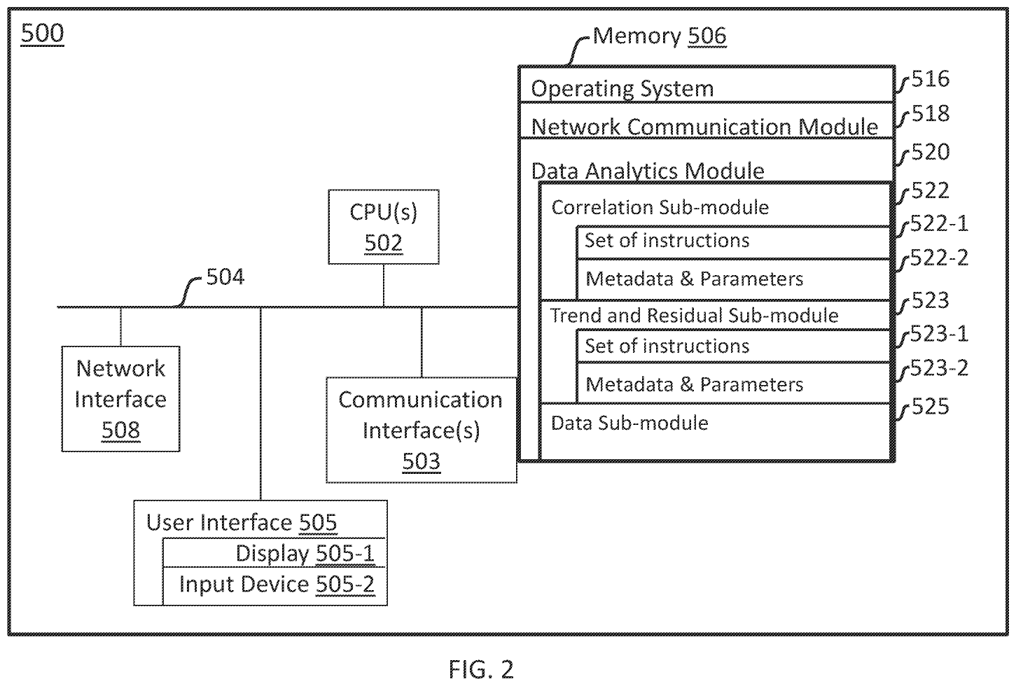

In another embodiment, where there are more than two highly-correlated features, a recursive solution can be used. For example, if three features are highly correlated, trend 1_2_3 can be fit to trend 1_2 and feature 3. The residual of trend 1_2_3 and feature 3 can also be used. FIG. 2 is a block diagram illustrating a data analytics system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the data analytics system 500 includes one or more processing units (CPUs) 502, one or more network interfaces 508 and/or other communications interfaces 503, memory 506, and one or more communication buses 504 for interconnecting these and various other components. The data analytics system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store well-logs, seismic, production data, and/or geologic structure information.

In some embodiments, memory 506 or the non-transitory computer readable storage medium of memory 506 stores the following programs, modules and data structures, or a subset thereof including an operating system 516, a network communication module 518, and a data analytics module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the data analytics module 520 executes the operations disclosed herein. Data analytics module 520 may include data sub-module 525, which handles the dataset including all available geological, geophysical, petrophysical, and production data. This data is supplied by data sub-module 525 to other sub-modules.

Correlation sub-module 522 contains a set of instructions 522-1 and accepts metadata and parameters 522-2 that will enable it to identify highly-correlated features of the data. The trend and residual sub-module 523 contains a set of instructions 523-1 and accepts metadata and parameters 523-2 that will enable it to calculate the trend and residual of the highly-correlated features which are then used in optimization methods to fit the non-linear trend and residual to a response variable. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing data and generating images. For example, any of the sub-modules may optionally be able to generate a display that would be sent to and shown on the user interface display 505-1. In addition, any of the data or processed data products may be transmitted via the communication interface(s) 503 or the network interface 508 and may be stored in memory 506.

The method described above is, optionally, governed by instructions that are stored in computer memory or a non-transitory computer readable storage medium (e.g., memory 506 in FIG. 2) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, the method is described as being performed by a computer system, although in some embodiments, various operations of the method are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of data analytics, comprising:
a. receiving, at one or more computer processors, a training dataset representative of a subsurface volume of interest;
b. identifying, via the one or more computer processors, at least two highly-correlated features in the training dataset;
c. calculating, via the one or more computer processors, a trend of the at least two highly-correlated features;
d. calculating, via the one or more computer processors, a residual of at least one of the highly-correlated features and the trend; and
e. using data analytic methods on features in the training dataset that include one or more of these trend and residual combinations to predict a response variable.

2. The method of claim 1 wherein the response variable is hydrocarbon production.

3. The method of claim 1 wherein the data analytic methods generates a neural network.

4. The method of claim 3 further comprising using the neural network with a second dataset to generate a predicted response variable.

5. The method of claim 1 wherein more than two highly-correlated features are identified in the data and further comprising finding a recursive solution.

6. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at one or more processors, a training dataset representative of a subsurface volume of interest;
b. identify, via the one or more processors, at least two highly-correlated features in the training dataset;
c. calculate, via the one or more processors, a trend of the at least two highly-correlated features;
d. calculate, via the one or more processors, a residual of at least one of the highly-correlated features and the trend; and
e. use data analytic methods on features in the training dataset that include one or more of these trend and residual combinations to predict a response variable.

7. The system of claim 6 wherein the response variable is hydrocarbon production.

8. The system of claim 6 wherein the data analytic methods generates a neural network.

9. The system of claim 8 further comprising using the neural network with a second dataset to generate a predicted response variable.

10. The system of claim 6 wherein more than two highly-correlated features are identified in the data and further comprising finding a recursive solution.

11. A non-transitory computer readable storage medium storing one or more programs, the one or more programs comprising instructions, which when executed by an electronic device with one or more processors and memory, cause the device to:
a. receive, at one or more processors, a training dataset representative of a subsurface volume of interest;
b. identify, via the one or more processors, at least two highly-correlated features in the training dataset;
c. calculate, via the one or more processors, a trend of the at least two highly-correlated features;
d. calculate, via the one or more processors, a residual of at least one of the highly-correlated features and the trend; and
e. use data analytic methods on features in the training dataset that include one or more of these trend and residual combinations to predict a response variable.

12. The device of claim 11 wherein the response variable is hydrocarbon production.

13. The device of claim 11 wherein the data analytic methods generates a neural network.

14. The device of claim 13 further comprising using the neural network with a second dataset to generate a predicted response variable.

15. The device of claim 11 wherein more than two highly-correlated features are identified in the data and further comprising finding a recursive solution.
